(19) United States
(12) Patent Application Publication
(10) Pub. No.: US 2009/0164667 A1
(43) Pub. Date: Jun. 25, 2009

(54) Synchronizing of Personal Content

(75) Inventors: Rainbow Zhang, Nanjing (CN); Sandeep Adwankar, Buffalo Grove, IL (US); X. H. Li, Taiyuan (CN); Tony Xu, Nanjing (CN)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/963,153

(22) Filed: Dec. 21, 2007

(51) Int. Cl. G06F 15/16

(52) U.S. Cl. 709/248

(57) ABSTRACT

A method of synchronizing personal content between remote and local devices includes sending a PIM sync command with a last sync timestamp from the local device to the remote device and receiving at the local device a PIM change report. The PIM change report includes PIM changes in the remote device. The method also includes scanning a change log of the local device for PIM changes in the local device occurring after the last sync timestamp, comparing PIM changes in the remote device and PIM changes in the local device, saving new personal content into a PIM database in the local device, and updating a mapping table with objectID pairs of the new personal content.

### BACKGROUND

As the number of data devices available to a user increases, synchronization of personal information, often called personal information management (PIM), between devices becomes more important especially with many devices in a wireless network. Systems and methods for implementing continuous synchronization of PIM applications between a host desktop computer and a client handheld device are desired.

Some wireless handheld devices in wireless networks may implement PIM applications and provide personal information services such as calendar, contacts, tasks, memos or the like. Some of these wireless handheld devices are capable of wireless synchronization with the desktop computer. For example, information is transferred between the desktop computer and the handheld device to update each. However, these wireless handheld devices usually utilize a pull-based technique where the synchronization only happens on a periodic basis when asked or when the devices are connected and then are prompted by the user to synchronize via synchronization software for the device.

Many wireless handheld devices are not capable of continuous synchronization to update the information stored on the desktop computer and the handheld devices when changes are made to the personal information stored on either the handheld devices or the desktop computer. A need has arisen for systems and methods for implementing periodic synchronization of PIM applications between a desktop computer and a handheld device.

### SUMMARY

An embodiment of a method of synchronizing personal content between remote and local device includes sending a PIM synchronization (sync) command with a last sync timestamp from the local device to the remote device and receiving at the local device a responsive PIM change report. The PIM change report includes PIM changes in the remote device. The method also includes scanning a change log of the local device for PIM changes in the local device occurring after the last sync timestamp, comparing PIM changes in the remote device and PIM changes in the local device, saving new personal content into a PIM database in the local device, and updating a mapping table with objectID pairs of the new personal content.

Another method embodiment of synchronizing personal content includes receiving from a local device a PIM sync command at a remote device, decoding a last sync timestamp from the PIM sync command, scanning a change log of the remote device for PIM changes in the remote device occurring after the last sync timestamp, encoding the PIM changes in the remote device into a remote device report and sending the remote device report to the local device. The method also includes receiving at the remote device a local device report that includes PIM changes in the local device after the last sync timestamp where the PIM changes in the local device include new personal content, recovering the new personal content from the local device report, saving the new personal content in a PIM database in the remote device, and updating a mapping table with objectID pairs of the new personal content.

Another embodiment of a method of synchronizing personal content includes altering a PIM database in a remote device according to user inputs where the altering includes at least one of adding, deleting and modifying new personal content. The method further includes entering in a change log a report of the new personal content when a user alters the PIM database and broadcasting over a network an advertisement when the report of new personal content is entered in the change log where the advertisement includes a deviceID, an objectID and an action type. The method also includes receiving at the remote device from a local device browse command, decoding the objectID from the browse command, scanning a change log of the remote device for PIM changes in the remote device identified by the objectID, encoding the PIM changes into a remote device report, and sending the remote device report to the local device.

Another method embodiment of synchronizing personal content includes receiving over a network an advertisement that reports when new personal content is produced in a remote device. The advertisement includes a deviceID, an objectID and an action type. The method further includes determining whether a local device has interest in the new personal content of the remote device, and sending a browse command to the remote device when the local device has interest in the new personal content of the remote device where the browse command includes the objectID. The method further includes receiving at the local device a remote device report that includes the new personal content defined by the objectID, recovering the new personal content from the remote device report, saving the new personal content in a PIM database in the local device, and updating a mapping table with objectID pairs of the new personal content.

Yet another embodiment of a method of synchronizing personal content includes sending a PIM sync command with a last sync timestamp from a local device to a remote device and receiving at the local device a responsive PIM change report where the PIM change report includes PIM changes in the remote device and the PIM changes include a multimedia content objectID and media content. The method further includes saving the media content in a PIM database in the local device, according a new local content ID according to media type, replacing the multimedia content objectID with the new local content ID, and updating a mapping table with the new local content ID of the media content.

Another method embodiment of synchronizing personal content includes receiving from a local device a PIM sync command at the remote device and decoding a last sync timestamp from the PIM sync command. The method further includes scanning a change log of the remote device for PIM changes in the remote device occurring after the last sync timestamp where the PIM changes include multimedia content objectID and media content, encoding the PIM changes in the remote device in a remote device report wherein the encoding includes replacing the multimedia contentID with an objectID and encoding the media content, the multimedia contentID and the objectID into the remote device report, and then sending the remote device report to the local device.

### BRIEF DESCRIPTION OF DRAWINGS

The invention will be described in detail in the following description of preferred embodiments with reference to the following figures.

FIG. 1 is a flow chart depicting a personal content synchronization sequence at the local device when two devices discover each other.

FIG. 2 is a flow chart of a method for personal content synchronization at the remote device when two devices discover each other.

FIG. 3 is a flow chart of a method for online personal content synchronization at the local device when two devices discover each other and one personal content change happened on one peer device.

FIG. 4 is a flow chart of a method for online personal content synchronization at the remote device when two devices discover each other and one personal content change happened on one peer device.

FIG. 5 is a flow chart of a method for personal content synchronization at the local device of composite content followed up with multimedia content when two devices discover each other.

FIG. 6 is a flow chart of a method for personal content synchronization at the remote device of composite content followed up with multimedia content when two devices discover each other.

FIG. 7 is a schematic block diagram of local and remote devices depicting PIM database, change log and mapping table data storage and CDS, change log and PIM software control modules of instructions, according to an embodiment.

FIG. 8 is a schematic block diagram of a computer system.

### DETAILED DESCRIPTION OF EMBODIMENTS

The embodiments include peer-to-peer synchronization of personal content, and synchronization of personal content with multimedia content, such as ringtone and pictures. Synchronization is but a part of the broader topic of Personal Information Management (PIM). Personal information includes any information added to a device by a user. Information that is personal to the user's device and not included in identical devices of other users is personal information. Examples of personal information include contacts, calendars, pictures and ring tones.

The embodiments include methods for synchronizing personal content information between two devices without using account information at a central server. Some embodiments also synchronize composite information that includes both personal content (e.g., contact information and calendar information) followed by multimedia content (e.g., pictures and ring tones), and such embodiments are well suited for synchronizing composite content types with both personal and multimedia content (e.g. phone book with pictures). Some embodiments enable peer-to-peer personal information to be synchronized by using the device discovery and capability exchange of UPnP (Universal Plug and Play) devices. Some embodiments synchronize personal information using both events as well as a change log mechanism.

Content Directory Service (CDS) is often seen as a core kernel in devices with UPnP AV (Universal Plug and Play, Audio Video). CDS searches and locates all Audio/Video content in the local file system and composes them into a tree hierarchy structure. For example, CDS may organize Audio/Video content in a folder (called Root folder here) where the Root folder has three sub-folders as depicted in Table 1. The CDS assigns a unique ID to each entry in the folders. When other devices browse the device holding these files, the other devices will see this tree hierarchy. For example, a device might browse the CDS directory by ID in order to locate the content that has been assigned to the ID.

Embodiments discussed herein extend the concepts of CDS to generalize these concepts to a generalized hierarchal directory service, an extended CDS. The extended CDS further includes other file types of PIM content such as contact information and calendar information. Embodiments enumerate personal information content records in the device's extended CDS as well as Audio/Video content of more traditional CDS. The CDS is extended to cover the personal content as nodes into the tree hierarchy as shown in Table 2.

TABLE 1

```
\Root folder
    \Audio folder
        Happy Christmas.mp3
        Goodbye friends.mp3
    \Video folder
        Gone with the wind.mpeg
    \Picture folder
        Spring outing.jpg
        Wedding.jpg
```

TABLE 2

```
\Root folder
    \Audio folder
        Happy Christmas.mp3
        Goodbye friends.mp3
    \Video folder
        Gone with the wind.mpeg
    \Picture folder
        Spring outing.jpg
        Wedding.jpg
    \Contact folder
        Frank_Ling
        James_Bond
    \Calendar folder
        Weekly meeting, every
            Monday, 10:00~11:00AM
        Meeting with sales, March 27,
            14:00PM, Jim's Factory 32F
```

For example, the CDS is extended to a more generalized hierarchal directory service to additionally search for and locate personal information content records such as contact and calendar information, in the local file system and compose them into the tree hierarchy structure. This extended CDS may also organize Audio/Video and personal information content in a folder (called Root folder here) where the Root folder has five sub-folders as depicted in Table 2. Each personal content record will be treated as an object in this hierarchal directory tree and have a unique objectID.

In addition to an extension of CDS, embodiments also add a change log module. The change log module monitors and saves each change that happens in local personal content and multimedia content of a device. Each change is saved together with an exact timestamp in the change log. For each changed object, a simple message of change information, such as content, objectID and change action, is broadcasted to all other devices available in the same local network using IP (Internet protocol). Those devices which receive the broadcast event and have interest on this content can request detail information about this object by browsing the device with the objectID as a search criteria.

When two devices synchronize their personal content information, one device (call it peer device 1) sends a timestamp to the other device (call it peer device 2). The timestamp is the point in time when the last synchronization occurred. However, a ZERO timestamp means that the two devices were never synchronized. When peer device 2 receives the timestamp from peer device 1, the change log module of peer device 2 determines how many entries, and the objectID of the entries, exist in its change log and have a timestamp later than the last synchronization timestamp when peer devices 1 and 2 were last synchronized.

In some embodiments, peer device 1 also calculates its local changes. The change log module of peer device 1 determines how many entries, and the objectID of the entries, exist in its local change log and have a timestamp later than the last synchronization timestamp when peer devices 1 and 2 were last synchronized. Peer device 1 receives changes from peer device 2. Then, peer device 1 compares the changes received from peer device 2 with its local changes.

When it is determined that an object has changed in both devices, a conflict condition exists, and the conflict is resolved by pre-defined conflict management rules. For example, the conflict management rule might be set to any one of “Local win”, “Remote win”, or “Keep latest”. “Local win” means keeping the local personal content object if a conflict condition exists. “Remote win” means keeping personal content object from remote peer device if a conflict condition exists. “Keep latest” means keeping the personal content object that has been more recently changed, no matter whether it is from the remote peer device or the local peer device.

In other embodiments, personal content with multimedia content combined in a remote device are synchronized with a local device. An example of personal content with multimedia content combined is, for example, contact information combined with a picture and a ring tone. The above described extended CDS and change log module support synchronization of both multimedia and personal PIM content. Using the described principals, composite synchronization of personal content followed with multimedia content are also synchronized. A detail logic flow is discussed below.

An example of a system operable to synchronize personal content is a desktop computer and mobile device such as a cell phone. However, the system described herein is an example, and other embodiments have no such limitation. Examples of the system are more generally characterized as a peer to peer solution which can synchronize PIM information between any type of personal device, such as PDA, STB, mobile phone, laptop etc. The system is also operable to provide composite synchronization of personal content followed with multimedia content. Technology of universal plug and play (UPnP) may be used for one device to automatically discover a peer device and begin the synchronization process.

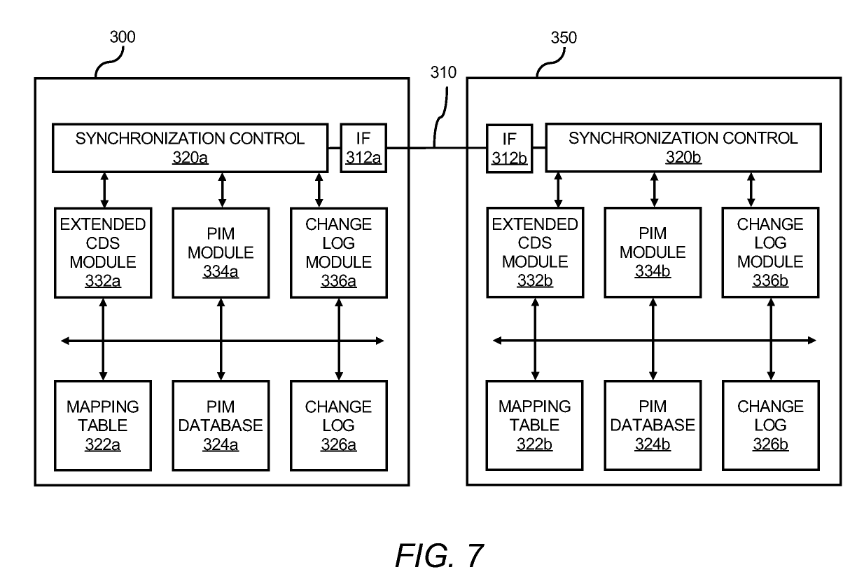

FIG. 7 depicts local device 300 and remote device 350. The local and remote devices are coupled by wireless data link 310 such as BlueTooth or WiFi using appropriate interfaces 312a and 312b, but may be wired together. The devices includes mapping table 322a-b, PIM databases 324a-b and change logs 326a-b, the functions of which are herein described. The devices include extended CDS modules 332a-b containing instructions operable to perform the extended CDS functions discussed herein. The devices include PIM modules 334a-b containing instructions operable to perform the PIM functions discussed herein. The devices include change log modules 336a-b containing instructions operable to perform the change log functions discussed herein.

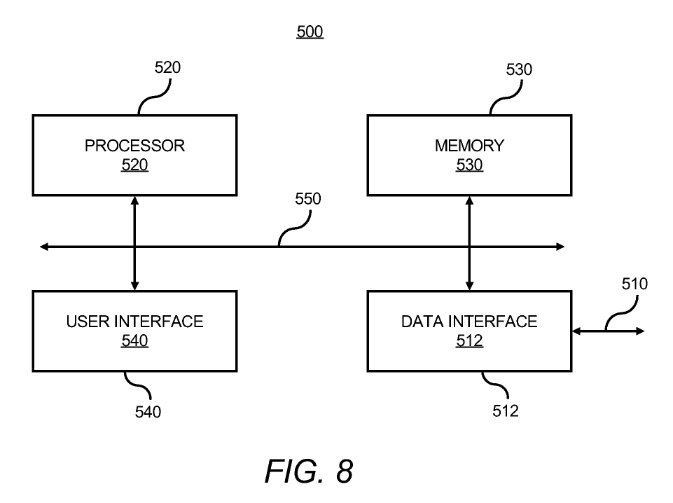

Often the device is implemented in a computer 500 (FIG. 8) with a processor 520 and a memory 530 for storing both data and program instructions. The computer includes a user interface 540 and a data or communications interface 512 (see 312 of FIG. 7). Data interface 512 is coupled to wireless or wired link 510 (see 310 of FIG. 7). Often processor 520, memory 530, user interface 540 and data interface 512 are coupled to each other by one or more buses 550. Portions or all of computer 500 may be implemented in an application specific integrated circuit (ASIC), a gate array or even discrete components.

The mapping table stores data including both contact and calendar mapping data. Each entry in the mapping table includes an ID number (e.g., an integer) unique within the device, a global ID unique to the world (or at least the synchronizing devices), and a value (e.g., a switch integer) to distinguish content type (e.g., calendar information or contact information). For composite synchronizing where the contact information is associated with, for example, a picture, the contact entry within the mapping table also has a picture ID unique within the device and/or possibly an ID unique within the device associated with a sound or ring tone or even a short motion picture clip.

The PIM database includes the actual content of calendar information, contact information, picture, sound or ring tone or even a short motion picture clip. The extended CDS searches the PIM database to produce a hierarchal directory of entries in the database where each entry is identified as one of calendar information, contact information, picture, sound or ring tone, a short motion picture clip or other data and identified by an ID unique to the device. This same ID that is unique to the device is used later in the mapping table as synchronization occurs.

As a user locally adds, modifies or deletes PIM content, the content itself is stored in, modified in or deleted from the PIM database by the PIM module and a new ID is assigned when new content is added. The event of adding, modifying or deleting PIM content is recorded in the change log by the change log module as to the type of change (e.g., add, modify or delete) along with its locally unique ID and a timestamp.

When new PIM content that has been locally added to the local PIM database and recorded in the local change log is synchronized with a remote device, a new globally unique ID is created for use in both local and remote devices. The globally unique objectID is entered in the appropriate field of the mapping table along with the a first locally unique ID for the calendar information or contact information pointing to the content in the PIM database, and the value to distinguish content type. For composite entries (i.e., containing multimedia), the mapping table also stores a second locally unique ID for the media content (e.g., picture, sound or ring tone or even a short motion picture clip that is associated with the PIM content).

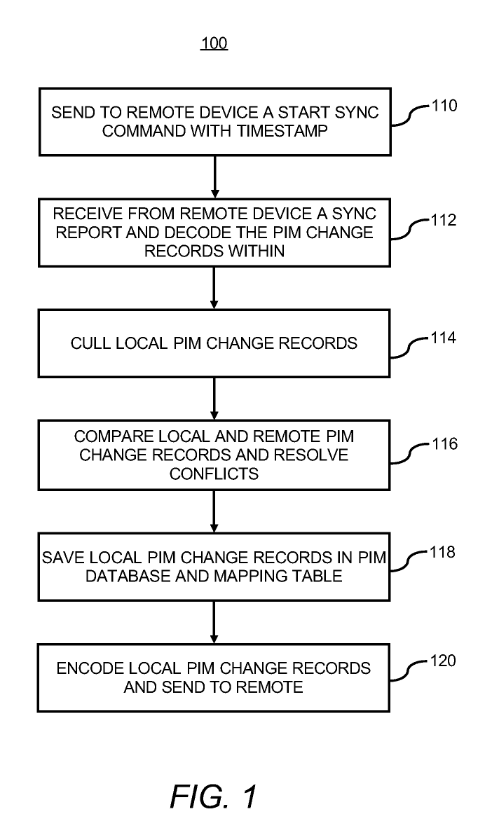

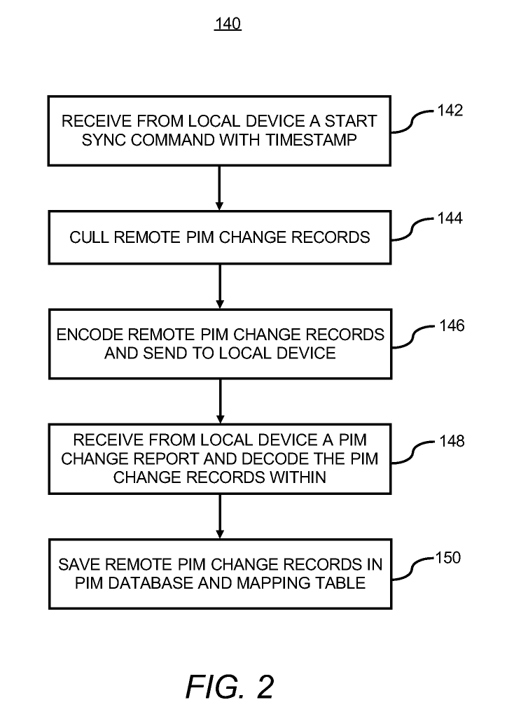

An example of synchronizing personal content is described with respect to FIGS. 1 and 2. FIG. 1 is an example of the synchronizing acts 100 performed in the local device, and FIG. 2 is an example of the synchronizing acts 140 performed in the remote device. In this example, the synchronizing is initiated in the local device. For example, the local device automatically detects a presence of an active remote device. At step 110 (FIG. 1), the local device sends to the remote device a PIM sync command requesting synchronization with the remote device. The PIM sync command includes a timestamp at which the last synchronization was performed. The timestamp may be set to ZERO in order to indicate that the local and remote devices have never been synchronized before. At step 142 (FIG. 2), the remote device receives the PIM sync command and recovers or decodes the last sync timestamp. In an alternative embodiment the timestamps are stored in the devices instead of sending a timestamp in the PIM synch command. For example, the local device sends to the remote device a PIM sync command requesting synchronization with the remote device. The PIM synch command includes an ID of the local device. The remote device stores a timestamp of a last synchronization and a device ID of the last synchronization with the local device. Thus, when the PIM synch command is received, the remote device can determine the timestamp of the last synchronization from its stored data. Thus, the local device sends a PIM sync command associated with a last sync timestamp to the remote device in response to detecting the presence of the remote device. This may include sending the last synch timestamp in the PIM sync command or sending information in the PIM sync command that may be used by the remote device to determine the last sync timestamp.

At step 144, the remote device culls through the change log for the remote device. When a change is encountered with a timestamp later than the last sync timestamp, a PIM change report is created that includes the change data, change type (e.g., add, modify, delete) and the timestamp for the change. In some embodiments, the report of the PIM change data is encoded into an XML format. In any format, the PIM change reports are encoded and sent back to the local device at step 146.

If the type of change is add, the local and remote devices communicate to establish a globally unique objectID. If the type of change is modify or delete, the globally unique objectID has already been established.

At step 112, the local device receives the encoded PIM change report and decodes the report to recover the PIM change objects, type of change (in this example, a modify) and associated timestamp within the report. In some embodiments, the report is encoded in an XML format. When using the XML format, the remote device functions as an XML server responding to a query from the local device with the PIM change information.

At step 114, the local device culls through its own local change log for PIM changes occurring after the last sync timestamp.

At step 116, the local device compares the changes to personal content from the remote device (e.g., acting as a server) and changes in the local personal content. A conflict condition exists when a change occurs to the same data in both the local and remote. The conflict condition is resolved by a user predefined conflict resolution rule such as “Local win”, “Remote win”, or “Keep latest”.

At step 118, the local device saves the resolved personal content into its own local PIM database and updates the mapping table with new or deleted local and global objectID pairs. A modify change type keeps the same objectID pairs.

At step 120, the local device also culls through its local change log for changes and encodes PIM changed objects, type of change and local and global objectID pairs, determined from the change log with timestamps after the last sync timestamp, into a report and sends the report to the remote device. As discussed above, some embodiments encode the PIM change data into XML format so that the remote device will receive a report as if it were coming from an XML server. Also, the devices may exchange their conflicts resolution policies, so each device can determine the objects stored on the other device after conflict resolution is applied.

At step 148, the remote device receives the PIM change report from the local device and decodes the PIM change data. At step 150, the PIM change objects are saved into the PIM database of the remote device according to the type of change and object ID, and the mapping table of the remote device is updated with the objectID pairs according to the type of change.

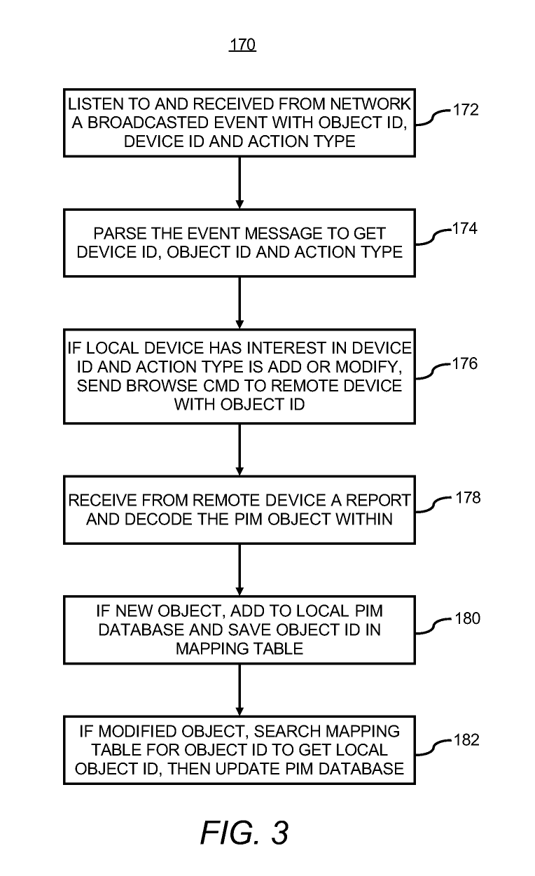

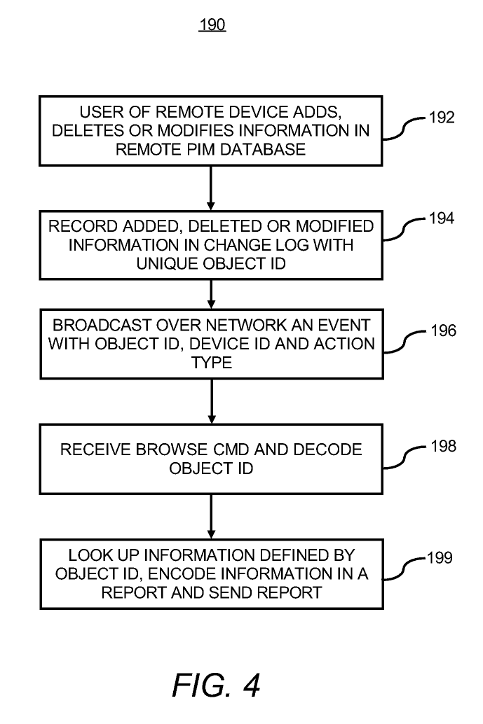

Another example of synchronizing personal content is described with respect to FIGS. 3 and 4. FIG. 3 is an example of the synchronizing acts 170 performed in the local device, and FIG. 4 is an example of the synchronizing acts 190 performed in the remote device. In this example, a user adds, modifies or deletes personal content information from the PIM database in the remote device at step 192 and records the change in the mapping table. At step 194, the PIM module reports the changed objectID and change type to the change log module. Then, at step 196 the remote device broadcasts this change to network with objectID, action type and the remote device's deviceID. The broadcasted change may include a broadcasted advertisement, which is message indicating new personal content is produced in a remote device, and the advertisement may include a deviceID, an objectID and an action type. By broadcasting the advertisement to all devices within range, there is no need to establish an initial one-on-one synchronization session with each device to determine whether any new information needs to be synchronized. Also, there may be no need to determine when or how previous modifications and synchronizations occurred, because a report is sent with changes to devices requesting synchronization, as described below.

At step 172, the local device receives the broadcasted event. At step 174 the local device parses the received broadcasted event to recover the deviceID, objectID and action type.

At step 176, if the local device is interested in synchronizing with the remote device identified by the recovered deviceID, and if the action type is ADD or MODIFY, the local device sends a “browse” command to remote device with the objectID to be browsed. A device may determine it is interested by storing a list of device IDs for devices that it desires to synchronize with. If the action type is ADD, the local and remote devices establish a globally unique objectID to associate with the object.

At step 198, the remote device receives the “browse” command and decodes the globally unique objectID. At step 199, the remote device retrieves the added or modified personal content detail information from the PIM database identified by the globally objectID in the remote device (using the mapping table to translate the globally unique objectID into a local objectID to point to the content in the PIM database), formats the retrieved information into a report and sends the report to the local device. In some embodiments, the object content detail information from the PIM database is formatted into the report by encoding the personal content into XML.

At step 178, the local device receives the encoded report and then decodes the report into the PIM object, change type and objectID pairs (local and global). At step 180, if the object action type is ADD, the local device saves the object in the PIM database of the local device and assigns it a new local objectID. Then, the objectID pair, i.e., the newly assigned objectID and the decoded global objectID, is saved into mapping table.

At step 182, if this object action type is MODIFY, the local device searches for the decoded global objectID in the mapping table to lookup the local objectID in mapping table. Once the local objectID is found, the content decoded from the remote devices is saved in PIM database of the local device according to the local objectID.

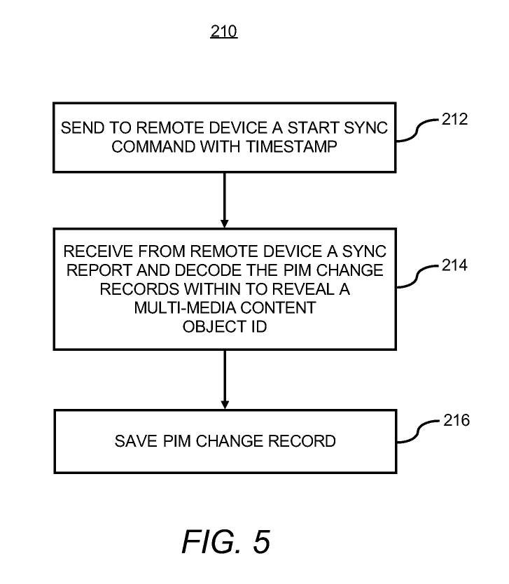

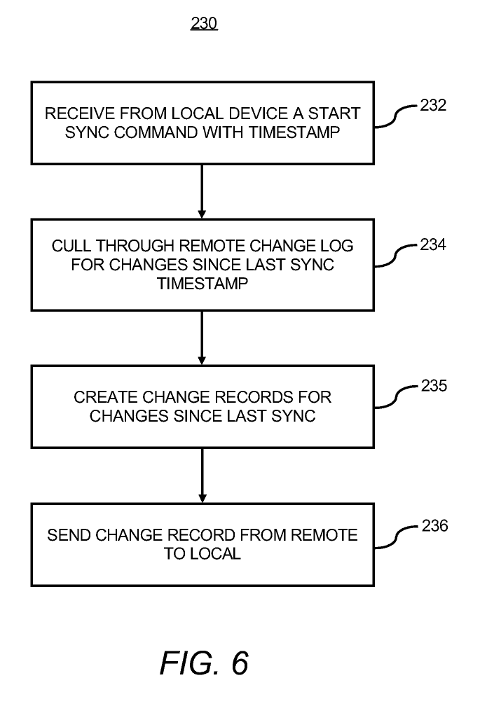

In yet another example of synchronizing personal content is described with respect to FIGS. 5 and 6. FIG. 5 is an example of the synchronizing acts 210 performed in the local device, and FIG. 6 is an example of the synchronizing acts 230 performed in the remote device. In this example, the synchronizing is initiated in the local device and the remote device reports a contact (or calendar even) is newly associated with picture or ringtone or other media.

At step 212 (FIG. 5), the local device sends to the remote device a PIM sync command requesting synchronization with the remote device. The PIM sync command request may be sent in response to devices discovering or otherwise detecting each other. The PIM sync command includes a timestamp at which the last synchronization was performed. The timestamp may be set to ZERO in order to indicate that the local and remote devices have never been synchronized before. At step 232 (FIG. 6), the remote device receives the PIM sync command and recovers or decodes the last sync timestamp.

At step 234, the remote device culls through the change log for the remote device. When a change is encountered with a timestamp later than the last sync timestamp, a report is created to send to the local device including a change record identifying each change since the last synchronization (step 235). The report includes a MODIFY change type (in this example), an existing globally unique objectID, a new objectID (e.g., pictureID or ringtoneID that links to the media content within the PIM database of the remote device) and the timestamp for the change.

In the present example, the changed data adds multimedia content such as picture or ringtone (e.g., its pictureID or ringtoneID) to an existing contact or calendar event. The mapping table links the pictureID or ringtoneID to the associated contact or calendar object. The media content is saved in the PIM database according to its pictureID or ringtoneID. The remote device retrieves the multimedia content and its objectID (e.g., pictureID or ringtoneID) from the extended CDS by looking for the pictureID or ringtoneID that is associated with the globally unique objectID of the media's associated contact or calendar event. The remote device encodes the pictureID or ringtoneID as the objectID, and then encodes these IDs with the personal content together into a report. In some embodiments, the report of the PIM change data with multimedia content is encoded into an XML format. In any format, the PIM change records are encoded and sent back to the local device at step 236.

At step 214, the local device receives the encoded PIM change report and decodes the report to recover the PIM change objects, the associated timestamp and a multimedia content objectID carried within the report. In some embodiments, the report is encoded in an XML format. When using the XML format, the remote device functions as an XML server responding to a query from the local device with this PIM change information.

At step 216, since this PIM record has a multimedia content objectID, the local device recovers the media content from the decoded report. The PIM module stores the media object in the PIM database and the extended CDS accords it a locally unique objectID (e.g., pictureID or ringtoneID). This locally unique objectID is recorded in the mapping table in a field associated with the contact (or calendar event) to which the media is associated.

The synchronization methods described above describe methods for automated discovery and performing synchronizations. There may be no need for a user to initiate discovery or synchronization. Users of the devices can set up the types of content to be synchronized, such as identifying the types of PIM data and/or media content to be synchronized. Also, security settings for one or more types of content can be set up. For example, for phonebook content, a user can select synchronizing the family's information or select friends' information for synchronization. Also, the user may restrict the devices that can synchronize this information through unique device IDs. For example, only device owned by family members may be allowed to synchronize this information.

One or more of the steps of the methods and other steps described herein and software described herein may be implemented as software embedded or stored on a computer readable medium and executed by a processor. The steps may be embodied by a computer program, which may exist in a variety of forms both active and inactive. For example, they may exist as software program(s) comprised of program instructions in source code, object code, executable code or other formats for performing some of the steps when executed. Modules include software, such as programs, subroutines, objects, etc. Any of the above may be stored on a computer readable medium, which include storage devices and signals, in compressed or uncompressed form. Examples of suitable computer readable storage devices include conventional computer system RAM (random access memory), ROM (read only memory), EPROM (erasable, programmable ROM), EEPROM (electrically erasable, programmable ROM), and magnetic or optical disks or tapes. Examples of computer readable signals, whether modulated using a carrier or not, are signals that a computer system hosting or running the computer program may be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general. It is therefore to be understood that those functions enumerated herein may be performed by any electronic device capable of executing the above-described functions.

Having described preferred embodiments of a novel method of synchronizing personal content (which are intended to be illustrative and not limiting), it is noted that modifications and variations can be made by persons skilled in the art in light of the above teachings. It is therefore to be understood that changes may be made in the particular embodiments disclosed which are within the scope of the invention as defined by the appended claims.

Having thus described the invention with the details and particularity required by the patent laws, what is claimed and desired protected by Letters Patent is set forth in the appended claims.

What is claimed is:

1. A method of synchronizing personal content comprising:
a local device automatically detecting a presence of an active remote device;
sending a personal information management (PIM) sync command associated with a last sync timestamp from the local device to the remote device in response to detecting the presence of the remote device;
receiving at the local device a PIM change report responsive to the PIM sync command, the PIM change report including PIM changes in the remote device;
saving new personal content associated with the PIM change report and received from the remote device into a PIM database organized as a content directory service in the local device; and
updating a mapping table in the local device with objectID pairs of the new personal content.

2. The method according to claim 1, wherein updating a mapping table in the local device comprises:
decoding the personal content to determine an objectID assigned to the personal content by the remote device;
assigning a new objected to the personal content; and
storing the new objectID and received personal content as an objectID content pair in the mapping table.

3. The method according to claim 1, further comprising:
scanning a change log of the local device for PIM changes in the content directory service of the local device occurring after the last sync timestamp;
comparing PIM changes in the remote device and PIM changes in the content directory service of the local device to determine whether a conflict exists;
resolving the conflict between the PIM changes in the local and remote device according to a user predefined conflict resolution rule when a conflict is determined to exist.

4. The method according to claim 1, wherein the sending a PIM sync command comprises:
encoding PIM changes in the local device into a local device report and sending the local device report to the remote device;
the PIM changes in the remote device are encoded in the PIM change report in an XML format; and
the receiving at the local device includes decoding the PIM changes to recover the new personal content.

5. The method according to claim 1, further comprising:
decoding the last sync timestamp from the PIM sync command at the remote device;
scanning a change log of the remote device for PIM changes in the remote device occurring after the last sync timestamp;
encoding the PIM changes in the remote device into the remote device report;
sending the remote device report to the local device;
receiving at the remote device a local device report that includes PIM changes in the local device after the last sync timestamp, the PIM changes in the local device including new personal content;
recovering new personal content from the local device report;
saving the new personal content from the local device report in a PIM database organized as a content directory service in the remote device; and
updating a mapping table in the remote device with objectID pairs of the new personal content from the local device report.

6. The method according to claim 5, wherein:
the PIM changes in the remote device includes the new personal content from the local device report and a timestamp of when the new personal content was created; and
the encoding of PIM changes in the remote device encodes the PIM changes in the remote device report in an XML format.

7. A method of synchronizing personal content comprising:
detecting an altering of personal content in a PIM database organized as a content directory service in a remote device according to user inputs, the altering including at least one of adding, deleting and modifying the new personal content;
entering, in a change log, a report of the altered personal content in response to the altering of the personal content in the PIM database is detected;
broadcasting an advertisement when the report of new personal content is entered in the change log, the advertisement including a deviceID, an objectID and an action type;
receiving, at the remote device, a browse command transmitted from a local device in response to the broadcasted advertisement;
decoding an objectID from the browse command;
scanning a change log of the remote device for PIM changes in the remote device identified by the objectID;
encoding the PIM changes into a remote device report; and
sending the remote device report to the local device.

8. The method according to claim 7, wherein the advertisement is broadcasted to a plurality of devices in a network or is broadcasted wirelessly to any devices within range of the remote device.

9. The method of claim 7, wherein synchronizing personal content comprises:
receiving a broadcasted advertisement at a local device, wherein the advertisement reports when new personal content is produced in a remote device, the advertisement including a deviceID, an objectID and an action type;
determining whether the local device has interest in the new personal content of the remote device;
sending a browse command to the remote device when the local device has interest in the new personal content of the remote device, the browse command including the objectID;
receiving at the local device a remote device report that includes the new personal content defined by the objectID in response to sending the browse command;
recovering the new personal content from the remote device report;
saving the new personal content in a PIM database organized as a content directory service in the local device; and
updating a mapping table with objectID pairs of the new personal content.

10. The method according to claim 9, wherein the determining of whether a local device has interest in the new personal content of the remote device includes determining whether the local device has interest in the action type, the action type including one of ADD, DELETE or MODIFY the objectID.

11. The method according to claim 9, wherein the new personal content is encoded in the remote device report in an XML format; and
the recovering of the new personal content includes decoding the XML format of the remote device report.

12. The method according to claim 9, wherein the recovering of the new personal content includes decoding the remote device report into the PIM object, the action type and objectID; and
when the action type is ADD, the local device saves the PIM object in the PIM database of the local device, assigns it a new local objectID and then the new local objectID and the decoded objectID are saved in a mapping table.

13. The method according to claim 9, wherein the recovering of the new personal content includes decoding the remote device report into the PIM object, the action type and objectID; and
when the action type is MODIFY, the local device saves the PIM object in the PIM database of the local device, searches for the decoded objectID in pairs of objectIDs in a mapping table in the local device to find the local objectID and then replaces the prior local objectID with the a new local objectID in the mapping table, the new local objectID pointing to the newly saved PIM object.

14. The method according to claim 9, wherein the PIM changes include a multimedia objectID and associated media content, the method further comprising:
saving the media content in a PIM database in the local device;
assigning a new local content ID according to media type;
replacing the multimedia objectID with the new local content ID; and
updating the mapping table with the new local content ID of the media content.

15. The method according to claim 9, wherein the PIM changes in the remote device includes a timestamp of when the multimedia content objectID and the associated media content were created; and
the receiving of the PIM change report includes decoding the PIM changes in the remote device report in an XML format.

16. A local device operable to automatically synchronize with a remote device, the local device comprising:
a controller, an extended content directory service module, a PIM module, a change log module, a mapping table, a PIM database organized as a content directory service and a change log, wherein
the controller is operable to engage in automatic discovery of an active remote device and send a PIM sync command with a last sync timestamp to the remote device in response to detecting the remote device during discovery;
the controller is further operable to receive a PIM change report responsive to the PIM sync command, the PIM change report including new personal content in the remote device;
the change log module is operable to scan the change log for PIM changes recorded in the change log occurring after the last sync timestamp;
the controller is further operable to compare PIM changes received in the PIM change report and PIM changes recorded in the change log to determine whether a conflict exists;
the controller is further operable to resolve the conflict according to a user predefined conflict resolution rule when a conflict is determined to exist;
the PIM module is operable to save the new personal content into the PIM database based on the resolved conflict; and
the extended content directory service module is operable to update the mapping table with objectID pairs of the new personal content.

17. The system according to claim 16, wherein:
the PIM changes include a multimedia objectID and associated media content;
the PIM module is operable to save the media content in a PIM database and assign the media content a new local content ID according to a media type;
the controller is operable to replacing the multimedia objectID with the new local content ID; and
the extended content directory service module is operable to update the mapping table with the new local content ID of the media content.

18. A local device operable to automatically synchronize with a remote device, the local device comprising:
a controller, an extended content directory service module, a PIM module, a change log module, a mapping table, a PIM database organized as a content directory service and a change log, wherein
the controller is operable to receive a broadcasted advertisement that reports when new personal content is produced in a remote device, the advertisement including a deviceID, an objectID and an action type;
the controller is further operable to determine whether the system has interest in the new personal content of the remote device;
the controller is further operable to send a browse command to the remote device when the system has interest in the new personal content of the remote device, the browse command including the objectID;
the controller is further operable to receive a remote device report that includes the new personal content defined by the objectID;
the controller is further operable to recover the new personal content from the remote device report;
the PIM module is operable to save the new personal content in the PIM database; and
the extended content directory service module is operable to update the mapping table with objectID pairs of the new personal content.

19. A method of automatic synchronization for PIM without user interaction comprising:
creating a synchronization relationship between two devices including an identification of types of content to be synchronized between the devices, wherein the synchronization relationship is established using a unique device ID for each of the devices;
setting at least one security level for at least one of the types of content; and
after forming the synchronizing relationship, synchronizing the types of content between the security devices in accordance with the at least one security level without a user initiating the synchronization.

20. The method of claim 19, further comprising:
the two devices performing automatic discovery to perform the synchronization.
